(19) United States
(12) Patent Application Publication
(10) Pub. No.: US 2008/0085349 A1
(43) Pub. Date: Apr. 10, 2008

(54) BEVERAGE RECIPE COMPRISES TEA ELEMENTS AND VITASUGAR

(76) Inventor: Zhi-Ying Chen, Foster City, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/857,394

(22) Filed: Sep. 18, 2007

Related U.S. Application Data
(60) Provisional application No. 60/845,544, filed on Sep. 18, 2006.

(51) Int. Cl. A23F 3/00; A23L 1/22; A23L 1/30

(52) U.S. Cl. 426/534; 426/546; 426/597

(57) ABSTRACT

It has been well established that tea elements have broad health benefits, including anti-cancer, -atherosclerosis, -obesity, and -diabetes, and neuron-protection effects, etc. VitaSugar® IMO is a non-digestible health sweetener with a series of additional health benefits, e.g., prevention of colon cancer, constipation, and dental cavity, and promotion of favorable bacterial flora in human colon as prebiotic function, etc. A beverage comprises of these two elements will provide consumers a class of tasteful drinks with superior health benefits.

### CROSS-REFERENCE TO RELATED APPLICATION

This application claims the benefit of U.S. Provisional Application No. 60/845,544 filed Sep. 18, 2006.

### BACKGROUND

Soft drink beverage is consumed widely by a large number of people in the world. However, the most popular drinks contain large amount of sugar and are partially responsible for the prevalence of obesity involving almost one billion people in the world. It has been well established that obesity can cause serious health problems, including cancers, atherosclerosis, diabetes, etc. Therefore, some of the sugar-containing drinks have been banned from entering some schools in North America. This action is a signal calling for new and healthier beverage soft drinks.

Tea, prepared from the leaves of a small plant Camellia sinensis, has been consumed in China and India as a health drink for preventing and treating many illnesses for 5 thousand years. Tea can be divided into three categories according to their processing procedure: green tea is prepared by directly drying from tea leaves, black tea is prepared after a complete fermentation, and oolong tea is the representative product of semi-fermented tea. Pu-erh tea is prepared via a special procedure and it can also be classified as black tea. Recent evidences from laboratory and preclinical studies demonstrated that tea or its constituents tea polyphenols have a broad health beneficial effects, including inhibiting cancers induced by a wide spectrum of chemical carcinogens in rodents and other animals (Chen Z Y et al., Zhonghua Zhong Liu Zha Zhi 9:109, 1987 Chinese; Stoner D et al., J Cell Biochem Suppl., 22:169, 1995; Yang CS et al., Annu Rev Pharmacol Toxicol., 42:25, 2002; Cooper R et al., J Altern Compl Med., 11:639, 2005), killing cultured cancer cells of almost all cell types (Nassani I et al., Biochem Biophys Res Commun., 249:391, 1998; Mittal A et al., Int J. Oncol., 24:703, 2004; L'Allemain G., Bull Cancer 86:721, 1999; Adhami V W., J. Nutr., 133:2417 S, 2003), preventing atherosclerosis (Kuo K L J Agri Food Chem 53:480, 2005; Abe I et al., J Nat Prod., 64:1010, 2001; Abe I et al., Biochem Biophys Res Comm 268:767, 2000), and neron-degenrating diseases such as Alzheimer and Parkinson (Rezai-Zadeh K et al., J Neuroscience 25:8807, 2005; Mandel S et al., Mol Nutr Food Res 50:229, 2006), and anti-diabetes and -obesity in animal models. Almost all evidences point to tea polyphenols (also known as tea catechins), such as (−)-epigallocatechin 3-gallate (EGCG), (−)-epigallocatechin (EGC), (−)-epicatechin (EC), and (−)-epicatechin-3-gallate (ECG), theaflavin, thearubigins, and theaflavin 3.3′-digallate as its effective constituents, although caffeine has certain health beneficial effect. More recently, clinical trials have demonstrated that green tea or tea polyphenols (catechins) are effective in preventing and treating liver cancer (Zhang Z Q et al., Guangxi Prevention Medicine 1:1, 1995), prostate cancer (Bettuzzi et al., Cancer Res., 66:1234, 2006), leukemia (Shanafelt T D., Leukemia Res., 30:707, 2006), and papilloma-infected cervical lesions (Ahn W S et al., Euro J Cancer Prev., 12:383, 2003) in human subjects.

### SUMMARY

The present invention related to a recipe for making beverages comprise tea elements and isomalto-oligosaccharide (trade name VitaSugar® IMO to be used below, produced by BioNeutra Inc, Edmonton, Canada).

### DETAILED DESCRIPTION

VitaSugar® IMO is a low calorie sugar produced by BioNeutra Inc. (Edmonton, Canada). It is a product derived from starch composed of 4 to 7 units of glucose with enzyme-mediated altered chemical linkage between glucose units. It can not be absorbed by human digestion system because of the lack of enzyme to break the altered linkage. In addition to serving as a sweetener, VitaSugar® IMO has multiple health benefits as well, including promoting the growth of the favorable bacteria in human colon, preventing colon cancer, dental cavity, constipation and diarrhea, etc.

Although tea drinks have been consumed by many people in areas of the world, their taste, especially green tea's taste, is not appreciated by many others. In preliminary experiments, it has been found that appropriate percent of VitaSugar® IMO can significantly improve the taste of the tea drinks prepared by ether directly from tea leaves or from commercially available tea polyphenols. The taste of tea drinks starts to improve even when the VitaSugar® IMO is only 0.5% in the drinks, and become better and better when VitaSugar® IMO concentration is gradually increased to 5%, 10%, and up to 50% or higher. It is reasonable to expect that the taste of the VitaSugar-Tea drinks will be further improved if additional popular elements such as fruits and flavors are added.

Therefore, beverages comprise green tea and VitaSugar® IMO will become very popular not only because of their good taste but also of their excellent health beneficial effects.

### EXAMPLES

The invention is now illustrated by a number of examples.

### Example 1

A liquid VitaSugar Tea drink is prepared by mixing 500 millimeters of tea liquid with 5 to 150 grams of VitaSugar® IMO powder or syrup. The tea liquid is prepared by pouring 500 milliliters of boiling water into 1 to 100 grams or more of tea leaves, either green tea, black tea, oolong tea, or Pu-erh tea, followed by mixing for 30 minutes or longer and filtering. The VitaSugar Tea drink is filtered for sterilization before divided into 50- to 500-milliliter aliquots. The ratio between the tea leaves, VitaSugar and water can be variable. The production can be scaled up to industrial volume.

### Example 2

A liquid VitaSugar Tea drink is prepared by mixing 1 to 2,000 milligrams of tea polyphenols (the specifications of which, for example, are tea polyphenols 98%, catechins 80%, and EGCG 55%; but the tea polyphenols purity and each components are variable) with 500 milliliters of water and 5 to 500 grams of VitaSugar® IMO powder or syrup. The VitaSugar Tea is filtered for sterilization before divided into 50- to 500-milliliter aliquots. The production can be scaled up to industrial volume.

### Example 3

A liquid VitaSugar Tea drink is prepared by mixing 1 to 2,000 milligrams of EGCG with 500 milliliters of water and 5 to 500 grams of VitaSugar IMO powder or syrup. The VitaSugar Tea is filtered for sterilization before divided into 50- to 500-milliliter aliquots. The production can be scaled up to industrial volume.

### Example 4

A powder form of VitaSugar Tea drink is prepared by mixing 1 to 2,000 milligrams of tea polyphenols (the specifications of which, for example, are tea polyphenols 98%, catechins 80%, and EGCG 55%; but the tea polyphenols purity and each components are variable) with 5 to 500 grams of VitaSugar IMO powder. The powder of VitaSugar Tea is divided into 5- to 500-gram aliquots. The tea drink is prepared by dissolving the powder in appropriate volume of water immediately before being consumed. The production can be scaled up to industrial volume.

### Example 5

A powder form of VitaSugar Tea drink is prepared by mixing 1 to 2,000 milligrams of EGCG with 5 to 500 grams of VitaSugar IMO powder. The powder of the VitaSugar Tea is divided into 5- to 500-grams aliquots. The tea drink is prepared by dissolving the powder in appropriate volume of water immediately before being consumed. The production can be scaled up to industrial volume.

1. The recipe of beverages comprise tea components and VitaSugar® IMO.

2. The recipe of beverages in claim 1 may contain elements derived from different teas, including green tea, black tea, oolong tea, or pu-erh tea.

3. The beverages in claim 1 may be in powder form composed of variable ratios of tea elements and VitaSugar® IMO powder.

4. The beverages in claim 1 may be in water solution form composed of variable ratios of tea elements and VitaSugar® IMO.

5. The beverages in claim 1 may contain different ratios of tea elements and VitaSugar® IMO, for example, tea elements 1 milligram versus VitaSugar® IMO from 0.01 to 10,000 grams.

6. The beverage in claim 1 can be prepared in aliquots of different size, for example, from 10 grams to 25 kg or more in each aliquot, or from 10 milliliters to 50 liters or larger volume.

7. The tea components in the beverage of claim 1 can be the powdered tea leaves or extract prepared by water, ethanol, or other solvents.

8. The tea elements in claim 1 can be individual tea constituents such as (−)-epigallocatechin 3-gallate (EGCG), (−)-epigallocatechin (EGC), (−)-epicatechin (EC), and (−)-epicatechin-3-gallate (ECG), theaflavin, thearubigins, and theaflavin 3.3′-digallate, caffeine and others, or a mix of different amount of individual constituents.

9. The VitaSugar® IMO in claim 1 can contain 0.1% to up to 50% or higher of the beverage.

10. The recipe of the beverages in claim 1 can also contain elements other than green tea elements and VitaSugar® IMO, including that from fruits such as orange, pineapple, blueberry, and cherry, etc.

11. The recipe of the beverages in claim 1 can also contain elements other than tea elements and VitaSugar® IMO, including various flavors such as vanilla.

12. The recipe of the beverages in claim 1 can also contain elements other than tea elements and VitaSugar® IMO, including various sweeteners.
